(19) United States
(12) Patent Application Publication
(10) Pub. No.: US 2026/0071299 A1
(43) Pub. Date: Mar. 12, 2026

(54) APPARATUS AND METHODS FOR RARE EARTH ELEMENT RECOVERY AND PURIFICATION

(71) Applicant: Battelle Memorial Institute, Columbus, OH (US)

(72) Inventors: Harvey D. LEE, Columbus, OH (US); Bradley S. HEATER, Dublin, OH (US); Katarzyna H. KUCHARZYK, Columbus, OH (US)

(21) Appl. No.: 19/320,123

(22) Filed: Sep. 5, 2025

Related U.S. Application Data
(60) Provisional application No. 63/693,325, filed on Sep. 11, 2024.

(51) Int. Cl. C22B 59/00; B01D 15/42; B01J 20/26; C22B 3/20; C22B 4/04

(52) U.S. Cl. CPC C22B 59/00; B01D 15/424; B01J 20/26; C22B 3/205; C22B 4/04

(57) ABSTRACT

The present disclosure is directed at apparatus and methods for rare earth element recovery and purification. The apparatus and methods are preferably configured to apply to column-based chromatographic separation and purification of rare earth element(s) and recovery of rare earth element(s) from a mobile phase containing rare-earth element chelating agent(s).

### STATEMENT REGARDING FEDERALLY SPONSORED RESEARCH OR DEVELOPMENT

This invention was made with government support under Contract Number FA8650-22-C-7213 awarded by the Defense Advanced Research Projects Agency (DARPA). The government has certain rights in the invention.

### SEQUENCE LISTING

The instant application contains a Sequence Listing which has been submitted electronically in XML format and is hereby incorporated by reference in its entirety. Said XML copy, created on Aug. 22, 2025, is named BAT279US_SL.xml and is 3,792 bytes in size.

### TECHNICAL FIELD

The present disclosure is directed at apparatus and methods for rare earth element recovery and purification. The apparatus and methods are preferably configured to apply to column-based chromatographic separation and purification of rare earth element(s) and recovery of rare earth element(s) from a mobile phase containing rare-earth element chelating agent(s).

### BACKGROUND

Rare earth elements are often found in chelated forms. For example, gadolinium-based contrast agents (GBCAs) are used in diagnostic procedures, which have been chelated to reduce toxicity and facilitate secretion while increasing biocompatibility. Chelated europium and terbium have been suggested as a component for the security measures utilized in Euro banknotes. Namely, the energy absorbed by such chelates luminesce in red and green under special circumstances due to the energy absorbed by the chelate and transferred to the REE. This, however, renders the rare earth element generally inaccessible for downstream purification. Acid-based destruction measures would then have to be used to free the ions, which would then be brought back to neutral pH with relatively strong bases.

A need therefore remains for a more environmentally acceptable approach for recovery of rare earth elements from chelated rare earth elements. Namely, apparatus and methods to irreversibly deconstruct the chelator that minimizes or avoids the use of additional solvents, acids, bases or even water. Such an approach would then be particularly useful for recovery of rare earth elements from a chelated mobile phase resulting from protein-column based rare earth element separation and purification.

### SUMMARY

A method for rare earth element recovery and purification comprising: (a) providing a mixture of rare earth elements comprising one or more of first rare earth elements and one or more of a second rare earth elements; (b) providing a first chelating agent and chelating one or more of the first rare earth elements wherein one or more of the second rare earth elements remain unchelated; (c) introducing one or more of the first chelated rare earth elements and one or more of the unchelated second rare earth elements to a chromatography column having a stationary immobilized phase wherein said one or more of the first chelated rare earth elements pass through the column and one or more of the second unchelated rare earth elements are bound to the stationary immobilized phase; and (d) exposing one or more of the first chelated rare earth elements that pass through said column to ultraviolet irradiation and deconstructing one or more of the first chelated rare earth elements and recovering one or more of the first rare earth elements.

A method for rare earth element recovery and purification comprising: (a) providing a mixture of rare earth elements comprising one or more of first rare earth elements and one or more of second rare earth elements; (b) providing a chromatography column having a stationary immobilized phase and binding one or more of the first rare earth elements and one or more of the second rare earth elements to the stationary immobilized phase; (c) eluting the chromatograph column with a first chelating agent, wherein the first chelating agent chelates with one or more of the second rare earth elements and removes one or more of the second rare earth elements from the chromatography column, wherein one or more of the first rare earth elements remain bound to said column; (d) exposing one or more of the second chelated rare earth elements with ultraviolet irradiation and deconstructing one or more of the second chelated rare earth elements and recovering one or more of the second rare earth elements; (e) eluting the chromatography column with a second chelating agent wherein the second chelating agent chelates with one or more of the first rare earth elements and removes one or more of the first rare earth elements from the chromatographic column; and (f) exposing one or more of the first chelated rare earth elements with ultraviolet irradiation and deconstructing one or more of the first chelated rare earth elements and recovering one or more of the first rare earth elements.

A method for rare earth element recovery and purification comprising:
a. providing a mixture of rare earth elements comprising one or more of first rare earth elements and one or more of second rare earth elements;
b. providing a first chelating agent and chelating one or more of the first and second rare earth elements;
c. exposing one or more of the first and second chelated rare earth elements to ultraviolet irradiation and (i) deconstructing one or more of the second chelated rare earth elements to an unchelated form; (ii) maintaining one or more of the first chelated rare earth elements in chelated form; and
d. introducing one or more of the second unchelated rare earth elements and one or more of the chelated first rare earth elements to a chromatography column having a stationary immobilized phase wherein one or more of the second unchelated rare earth elements bind to the stationary immobilized phase and one or more of the chelated first rare earth elements pass through the chromatography column.

### FIGURES

FIG. 1 illustrates the first part of one preferred rare earth element (REE) recovery and procedure.

FIG. 2 illustrates the second part of one preferred rare earth element recovery and procedure.

FIG. 3 illustrates a second preferred rare earth element recovery and purification procedure.

FIG. 4 illustrates another preferred rare earth element recovery and purification procedure.

FIG. 5 illustrates an overall preferred system for rare earth element recovery and purification.

FIG. 6 illustrates a preferred apparatus to collect the output of a chromatograph column and provide for UV irradiation.

FIG. 7 illustrates the results of equimolar loading of Y, L, Nd and Sm onto a chromatographic column that employed a stationary immobilized protein phase of SEQ NO. 1, and the sequential elution of these rare earth elements off of the column.

FIG. 8 illustrates the percent recovery of the identified non-chelated and chelated rare earth elements from a column having a stationary immobilized protein phase having SEQ NO. 1.

FIG. 9 illustrates the percent recovery of the indicated rare earth elements when chelated and loaded onto the protein immobilized phase in the column described by SEQ NO. 1, both before and after UV treatment.

FIG. 10 illustrates a plot of relative fluorescence units (RFU) versus Eu concentration.

FIG. 11 illustrates a plot of observed RFU for the identified samples (Eu, Eu+EDTA) before UV treatment and then after UV treatment.

FIG. 12 illustrates the percent recovery of indicated REEs (Sm, Eu, Pr, Nd) when chelated and UV treated with different parameters including optimal wavelength and power consumption.

FIG. 13 illustrates the percent recovery of indicated REEs when chelated and UV treated at different concentrations of REE-chelator complex.

FIG. 14 illustrates the percent recovery of indicated REEs when chelated and UV treated for different amounts of time.

FIG. 15 illustrates the percent recovery of indicated REEs in washes and elutions of the purification process when chelated with citrate and UV treated.

FIG. 16 illustrates the percent recovery of indicated REEs with and without UV treatment for different chelating molecules.

FIG. 17 illustrates the purification of Dy from a mixture of REEs including Dy and Tb, resulting in up to 85% purity.

FIG. 18 illustrates further purification of Dy from a Tb/Dy mixture at 85% Tb by selective EDTA chelation, resulting in a purity of 97.1% with more than 11% recovery yield.

### DETAILED DESCRIPTION OF PREFERRED EMBODIMENTS

The present disclosure is directed at an apparatus and method for rare earth element purification. Reference to a rare earth element (REE) herein is reference to the following elements: Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr. Reference to a chelating agent is reference to a compound that bonds to a REE, typically through two or more coordinate covalent bonds and/or electrostatic interactions.

The chelating agents herein are contemplated to include but are not limited to the following: N-(2-acetamido)-2-aminoethanesulfonic acid (ACES), Acetylacetone, Acyclopa, N-(2-acetamido)iminodiacetic cortruacid (ADA) Alizarin, Alizarin Red S, Amidoxime, Amidoxime group, Aminoethylethanolamine, Aminomethylphosphonic acid, Aminopolycarboxylic acid, Aminotris(methylenephosphonic acid), Ammonium acetate, Aza-crown ether, 1,2-bis(o-aminophenoxy)ethane-N,N,N′,N′-tetraacetic acid), Bathocuproine, BDTH2, Benzotriazole, Benzoylacetone, (N,N-bis(2-hydroxyethyl)glycine) (Bicine), Bidentate chelators, BiPhePhos, Bipyridine, 2,2′-Bipyridine, Transition metal complexes of 2,2′-bipyridine, 2,2′-Bipyrimidine, 1,2-Bis(dicyclohexylphosphino)ethane, 1,2-Bis(dimethylarsino)benzene, 1,2-Bis(dimethylphosphino)ethane, 1,2-Bis(diphenylphosphino)benzene, 1,4-Bis(diphenylphosphino)butane, 1,2-Bis(diphenylphosphino)ethylene, Bis(diphenylphosphinoethyl)phenylphosphine, 1,2-Bis(diphenylphosphino)ethane, N,N-Bis(2-hydroxyethyl)-2-aminoethanesulfonic acid (BES), Calixarene, N-cyclohexyl-3-aminopropanesulfonic acid (CAPS), N-cyclohexyl-2-hydroxy-3-aminopropanesulfonic acid (CAPSO), Carcerand, Catechol, Cavitand, Chelating resin, Chelex 100 (styrene divinylbenzed copolymer containing paired iminodiacetate anions), 2-(N-cyclohexylamino)ethanesulfonic acid (CHES), Citrate, Citric acid, Clathrochelate, Corrole, Cryptand, 2.2.2-Cryptand, Cyclam, Cyclen, Cyclodextrin, B-Cyclodextrin, Deferasirox, Deferiprone, Denticity, Dexrazoxane, Diacetyl monoxime, Trans-1,2-Diaminocyclohexane, 1,2-Diaminopropane, 1,5-Diaza-3,7-diphosphacyclooctanes, 1,4-Diazacycloheptane, 1,5-Diazacyclooctane, Dibenzoylmethane, Diethylenetriamine, Diglyme, 2,3-Dihydroxybenzoic acid, Dimercaprol, 2,3-Dimercapto-1-propanesulfonic acid, Dimethyl-2,2′-bipyridine, 1,1-Dimethylethylenediamine, 1,2-Dimethylethylenediamine, Dimethylglyoxime, DIOP, Diphenylethylenediamine, 2,2′-Dipyridylamine, 1,5-Dithiacyclooctane, Domoic acid, DOTA (chelator), DOTA-TATE DTPMP, EDDHA (ethylenediamine-N,N′-bis(2-hydroxyphenylacetic acid), EDDS (ethylenediamine-N,N′-bis(2-hydroxyphenylacetic acid), EDTA (Ethylenediaminetetraacetic acid), EDTMP (ethylenediamine tetra(methylene phosphonic acid), EGTA (egtazic acid), Ethane-1,2-dithiol, Ethylenediamine, Ethylenediaminediacetic acid, Ethylenediaminetetraacetic acid, Etidronic acid, Ferroverdin, Fluo-4, Fura-2, Gallic acid, Gluconic acid, Glutamic acid, Glycine, Glyoxal-bis(mesitylimine), Glyoxylic acid, Glyphosate, 2,4,6-Heptanetrione, Hexaaza-18-crown-6, Hexafluoroacetylacetone, α-Hydroxyisobutyric acid (α-HIBA), Hinokitiol, (L-)Histidine, Homocitric acid, Hydroxyethylethylenediaminetriacetic acid (HEDTA), 4-(2-hydroxyethyl)-1-piperazineethanesulfonic acid (HEPES), Imidazole, Iminodiacetic acid, Indo-1, Iron(tetraphenylporphyrinato) chloride, Isosaccharinic acid, Kainic acid, Lactic acid, Lutetium (177Lu) oxodotreotide, Maleic acid, Malic acid, Malonate, 2-(N-morpholino)ethanesulfonic acid (MES), Metal acetylacetonates Metal dithiolene complex, Metallacrown, N-Methyliminodiacetic acid, 3-(N-morpholino) propanesulfonic acid (MOPS), Nickel bis(stilbenedithiolate), Nitrilotriacetic acid, Oxalic acid, Oxime chelants, Palladacycle Pendetide, Penicillamine, Pentetic acid, Phanephos, 1,10-Phenanthroline, O-Phenylenediamine, Phosphonate chelants, Phthalocyanine, Phytochelatin, Picolinic acid, Piperazine-N,N′-bis(2-ethanesulfonic acid) (PIPES), Polyaspartic acid, Porphine, Porphyrin, 3-Pyridylnicotinamide, 4-Pyridylnicotinamide, Pyrogallol, Quaterpyridine, Salicylic acid, Sarcophagine, Sodium acetylacetonate, Sodium citrate, Sodium diethyldithiocarbamate, Sodium polyaspartate, Succimer Terpyridine, N-Tris(hydroxymethyl)methyl-3-aminopropanesulfonic acid (TAPS), (N-tris(hydroxymethyl)methyl-2-aminoethanesulfonic acid) (TES), Tetraacetylethane, Tetramethylethylenediamine, Tetraphenylporphyrin, Tetrasodium EDTA, Thenoyltrifluoroacetone, Thia-crown ether, Thioglycolic acid, Thujaplicin, Tolyltriazole, TPEN, Transition metal porphyrin complexes, Triacetylmethane, 1,4,7-Triazacyclononane, Tributyl phosphate, Tridentate, Triethylenetetramine, 1,1,1-Trifluoroacetylacetone, 1,4,7-Trimethyl-1,4,7-triazacyclononane, Tris(hydroxymethyl)aminomethane (TRIS), 1,1,1-Tris(diphenylphosphinomethyl)ethane, N-[Tris(hydroxymethyl)methyl]glycine (Tricine), Trisodium citrate 1,4,7-Trithiacyclononane, TTFA (2-Thenoyltrifluoroacetone).

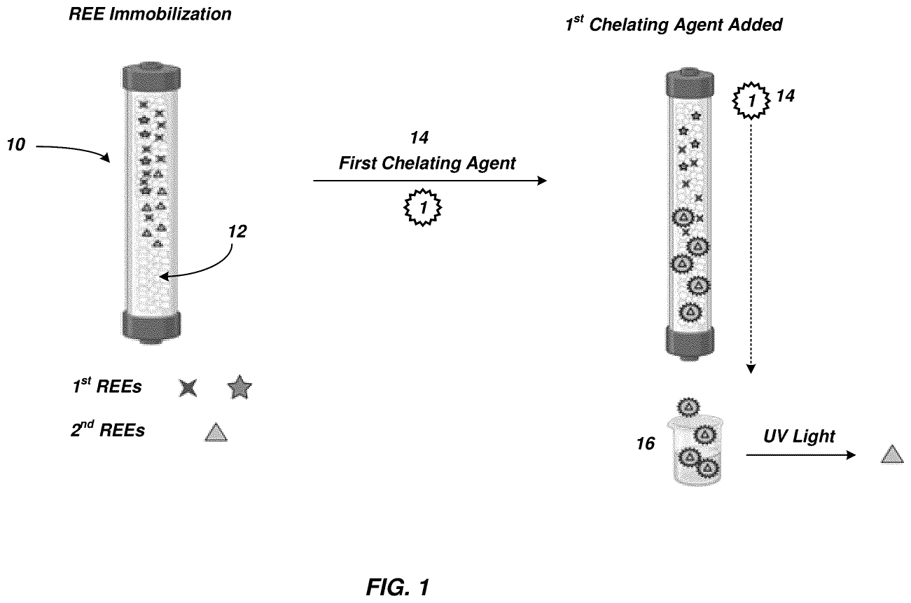

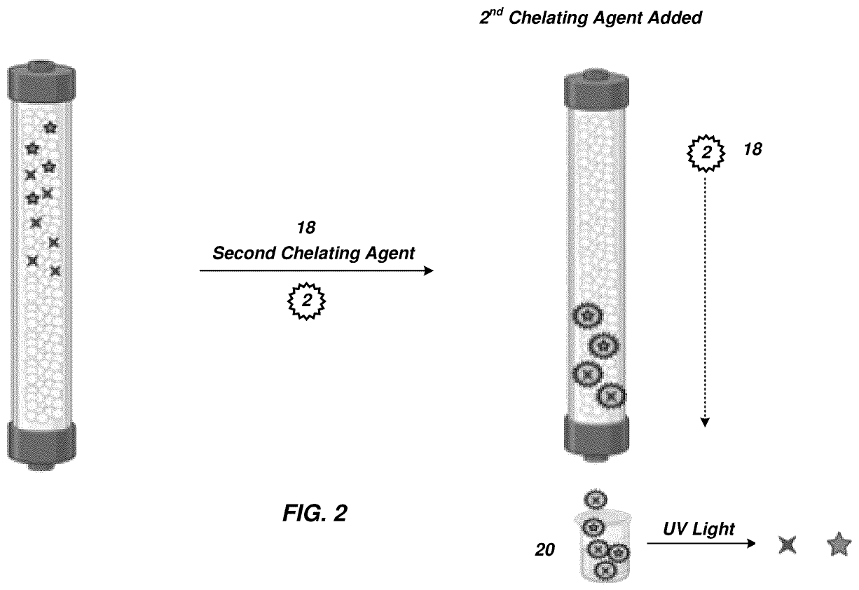

FIG. 1 illustrates the first part of one preferred REE recovery and purification procedure. A chromatographic column is shown at 10 having a stationary immobilized phase 12. The REEs preferably comprise a first group of one or more REE(s) identified as 1^{st} REE(s) and a second group of one or more REE(s) identified as 2^{nd} REE(s). The first and second group of such REE(s) have different relative affinity to the stationary immobilized phase as well as to a subsequently added first chelating agent 14 and second chelating agent 18 (see FIG. 2). The first chelating agent and second chelating agent may be different chelating agents (compositionally) or may also be the same chelating agent but present at different concentrations in the eluant or again, the same chelating agent in the eluant but at a different pH.

In this preferred example, the 1^{st} REE(s) are those that preferably have: (1) a relatively stronger binding affinity to the stationary immobilized phase 12 and a relatively weaker binding affinity to the subsequently added first chelating agent 14; and (2) a relatively weaker binding affinity to the stationary immobilized phase 12 and a relatively stronger binding affinity to second chelating agent 18. By contrast, the 2^{nd} REE(s) are those that have a relatively weaker binding affinity to the stationary immobilized phase 12 and a relatively higher binding affinity to the subsequently added first chelating agent 14.

As further illustrated in FIG. 1, upon introduction and elution of the column 10 with the above described first chelating agent 14, the 2^{nd} REE(s), which as indicated have a relatively higher binding affinity to the 1^{st} chelating agent 14 than the stationary immobilized phase 12, may be removed from the column 10. This results in recovery of 2^{nd} REE(s) as shown at 16 that are now chelated to the first chelating agent 14. The 1^{st} REE(s), which have a relatively stronger affinity to the stationary immobilized phase 12 and relatively weaker binding affinity to the 1^{st} chelating agent, therefore remain bound to the stationary immobilized phase 12. In addition, upon application of UV irradiation, the 2^{nd} REE(s) which are chelated to the first chelating agent, can be deconstructed and one or more of the 2^{nd} REE(s) can now be recovered in purified form. Deconstruction herein is reference to a breaking of the chelator/REE bonding, which allows for REE recovery.

As next illustrated in FIG. 2, after elution with the first chelating agent 14, one or more of the 1^{st} REE(s) that have a relatively stronger binding affinity to the stationary immobilized phase 12 than to the first chelating agent 14, will remain on the column. At this point one may now introduce and elute with a second chelating agent 18. The second chelating agent 18 is one that is now able to remove the 1^{st} REE(s) from the stationary immobilized phase 12. That is, since the 1^{st} REE(s) are such that they have a stronger binding affinity towards the second chelating agent 18 than to the immobilized phase 12, can be removed from the stationary immobilized phase 12 during elution with the second chelating agent 18. As shown at 20, the 1^{st} REE(s) are now chelated to the second chelating agent 18. As illustrated, the 1^{st} REE(s) may then similarly be exposed to UV irradiation and deconstructed from the second chelating agent and recovered in their REE form (i.e. without being bound to the chelating agent). The preferred UV irradiation is described further herein.

In connection with the above, it is contemplated, e.g., that the first REE(s) that have the relatively stronger binding affinity to the stationary immobilized phase than to a first chelating agent would comprise Tb and Dy and the second REE(s) that has the relatively higher binding affinity to the first chelating agent than the stationary immobilized phase can include La. The first chelating agent that then removes the La is contemplated to include a relatively low concentration of EDTA (e.g., in the micromolar range (μm) or 10-6 mol/liter). The second chelating agent that then removes Tb and Dy from the stationary immobilized phase is a higher concentration of EDTA (e.g., in the millimolar range (mM) or 10-3 mol/liter). The chelated La and chelated Tb and Dy so recovered via the FIG. 1 protocol can then be deconstructed upon exposure to UV irradiation.

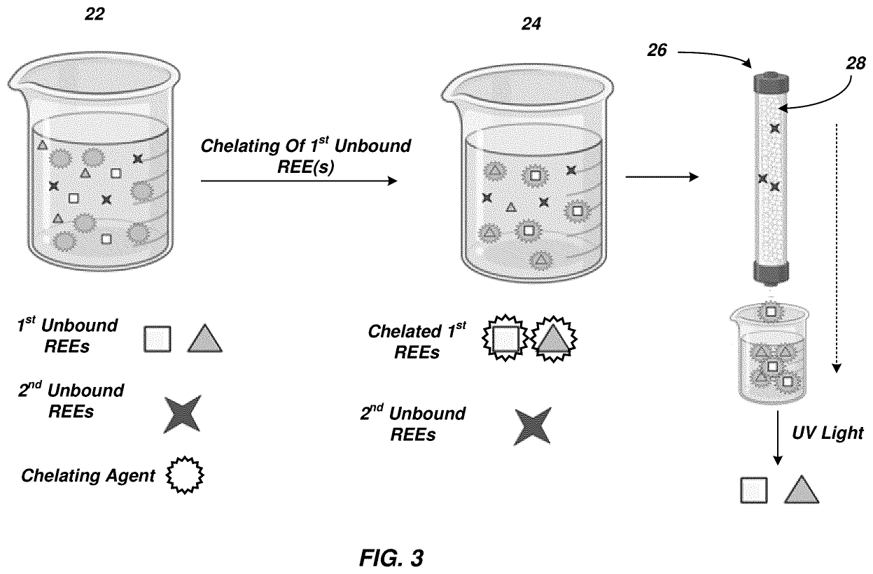

FIG. 3 illustrates a second preferred REE recovery and purification procedure. As illustrated, at 22 one initially provides one or more of 1^{st} unbound REE(s) and one or more of 2^{nd} unbound REE(s) in the present of a chelating agent. As shown at 24, the chelating agent is such that it selectively chelates one or more of the 1^{st} unbound REE(s). That is, one or more of the 1^{st} unbound REE(s) are such that they will selectively bind to the introduced chelating agent. However, the one or more 2^{nd} unbound REE(s) are such that they do not bind to the chelating agent. The mixture at 24 may then be eluted through column 26 and through the stationary immobilized phase 28 therein.

As therefore illustrated in FIG. 3, The one or more 2^{nd} unbound REE(s) are those that then have a relatively strong binding affinity for the stationary immobilized phase 28 within column 26. The one or more of the 1^{st} REE(s) that are chelated will now effectively pass through and can be readily washed from the column and recovered in their chelated form. The one or more of the 2^{nd} REE(s) that are bound to the stationary immobilized phase 28 can then be removed from the column in at least one of two ways. First, one or more of the 2^{nd} REE(s) may be eluted from the column by selection of an appropriate solvent protocol, such as a solvent protocol that adjusts and lowers pH or increases the concentration of the chelating medium. In addition, the one or more of the 2^{nd} REE(s) may be removed from the column by introduction of a chelating agent where the 2^{nd} REE(s) have a greater binding affinity for such chelating agent than the stationary immobilized phase within the column. Once again, any chelated REEs recovered from this purification protocol may then be exposed to ultraviolet light of the type described herein, to deconstruct the chelated REE(s) and release the REE(s) from their chelated configuration.

As therefore described, one or more of the 1^{st} REE(s) and/or one or more of the 2^{nd} REE(s) that may be recovered in chelated form can then preferably be exposed to UV irradiation which deconstructs such chelated REEs and released the REE. This release of the 1^{st} REE(s) or second REE(s) from the chelator via exposure to UV irradiation can now be preferably accomplished by minimizing or completely avoiding the use of additional solvents, acids, bases or even water to cause the chelating agent to release the REE. The release of the REEs in such manner makes them available for further downstream purification and recycling protocols.

The UV light or irradiation that is employed herein for deconstruction of the chelated REEs preferably has a wavelength in the range of 100 nm to 315 nm, including all individual values and increments therein. The UV light is contemplated to preferably be UVB and in the range of 280 nm to 320 nm or UVC and in the range of 200 nm to 280 nm. The chelated REEs are also preferably exposed to such UV light and the time of exposure is contemplated to be in the range of 30 minutes to 72 hours, including all individual values and increments therein, which may depend on the concentration of chelator-REE complexes as well as wavelength, power output, and sample positioning. Preferably, the chelated REEs would be placed in a continuous-flow chamber apparatus with a built-in UV source (provided as a low wavelength UV-C light source at 36 W or greater) that covers the total internal chamber volume, with a reflective interior surface and rotor.

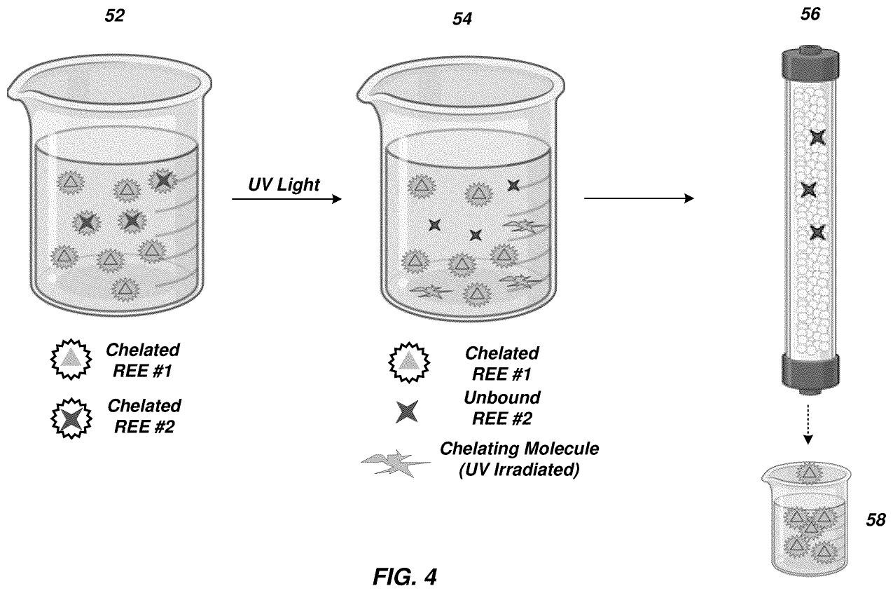

Additionally, chelator destruction herein by UV irradiation is such that by varying UV intensity, wavelength or duration of UV exposure, it is contemplated that such will allow for selective deconstruction of one chelator/REE binding interaction versus another chelator/REE binding interaction. Attention is directed to FIG. 4 to illustrate the use of UV irradiation to selectively deconstruct one chelator/REE binding interaction versus another. More specifically, as illustrated at 52, one initially provides a mixture of rare earth elements comprising one or more of first rare earth elements and one or more of second rare earth elements, along with a first chelating agent, that chelates one or more of the first and second rare earth elements. Then, as shown at 54, one exposes the mixture of the one or more first and second chelated rare earth elements to ultraviolet radiation which: (i) deconstructs one or more of the second chelated rare earth elements; and (2) maintains the one or more of the first chelated rare earth elements in chelated form. This selective deconstruction of the one or more second chelated rare earth elements relative to the one or more chelated first rare earth elements is contemplated to rely upon the use of a chelator that has relatively weaker binding characteristics to the second rare earth element(s) than the first rare earth element(s). Accordingly, it is contemplated that one may then adjust UV intensity, UV exposure times and UV wavelengths to selectively deconstruct one or more of the second chelated rare earth elements relative to the one or more first chelated rare earth elements.

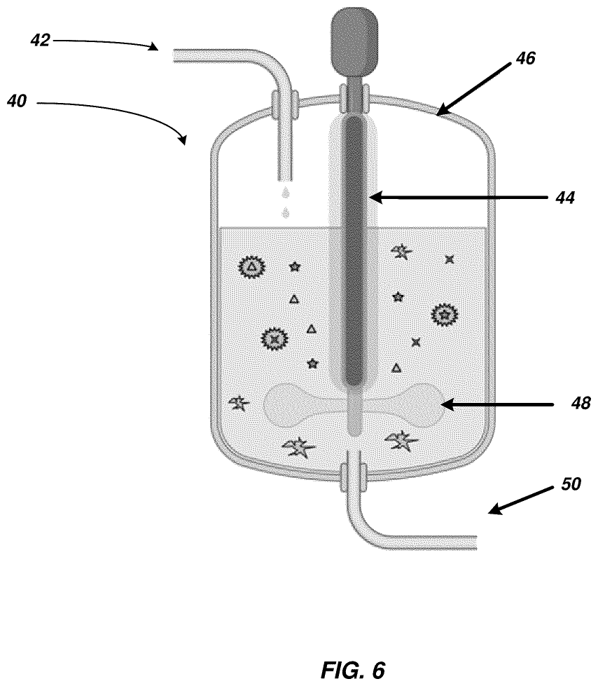

As next shown at 56, one then introduces one or more of the second unchelated rare earth elements and the one or more of the chelated first rare earth elements to a chromatography column having a stationary immobilized phase. Within the column, the one or more second unchelated rare earth elements bind to the stationary phase and as shown at 58 the one or more of the chelated first rare earth elements pass through the chromatography column. One can then elute from the column one or more of the second unchelated rare earth bound to the stationary immobilized phase, which stationary mobile phase can be a protein, as described herein. In addition, one or more of the first chelated rare earth elements that pass through the column can be introduced to an inlet of an apparatus that provides a UV lamp including a reflective inner layer to reflect UV light, to deconstruct and recover the one or more of the first chelated rare earth element. See FIG. 6.

In connection with the above, it is contemplated that the second REE(s) with the relatively lowest net bond enthalpy in association with a chelating agent may comprise a single species such as La, while the first REE(s) with relatively higher bond enthalpy may comprise the relatively heavier species such as Pr, Nd, Sm, Eu, Gd, and so on. After selective deconstruction of lower bond enthalpy products with UV irradiation, the second REE(s) would elute from the immobilized phase instead of the mobile phase. As the bonds that are in association with the second REE(s) are broken first, La would be immobilized onto the column while the group of first REE(s) pass through the column.

With repeated cycles of selective bond destruction for the relatively lowest net bond enthalpy, one may then isolate a mixture of REEs into pure, individual solutions. While some chelating agents may have a relatively higher net bond enthalpy in association with specific REE(s), many will have a preference towards lighter or heavier REE(s) in terms of atomic weight. It is therefore contemplated that one may initially select a combination of chelating agents and REEs based on such bond enthalpy values reported in existing literature, estimated from chemical structures with computational chemistry and thermochemical equations, or empirically derived with methods (including but not limited) to Differential Scanning calorimetry, Isothermal Titration calorimetry, Raman Spectroscopy, and Infrared Spectroscopy.

Chelating agent pairs for targeting specific REEs in a mixture were conveniently selected by initially sampling a given REE of interest with one or more selected chelating agents and identifying, e.g., a given chelating agent's ability to chelate or not chelate to such REE. In this case, the REE of interest and the starting mixture were the initial parameters readily evaluated. For example, targeting REEs of highest abundance is preferable as it requires relatively fewer passes in the purification process disclosed herein. Depending on the target REE, one can pair it with a chelator that directs it to exist in the flow through, wash, or elution fractions, which separate the REE of interest. Chelators with a relatively high differential of binding preference across the REEs (oftentimes quantified as Kdₐₚₚ) are preferred for the first and second purification methods as it depends on selective binding. Similarly, chelating molecules with a relatively higher differential across the REEs in terms of UV sensitivity (contemplated to depend on net bond enthalpy and energy absorption) are preferred for the third purification described herein, as it relies on selective bond destruction. It is also noted that the above sampling regarding chelating agents can also be conveniently applied to similarly: (1) select a given stationary immobilized phase where a first chelated rare earth element passes and a second unchelated rare earth element binds to the stationary immobilized phase; or (2) select a given stationary immobilized phase containing a plurality of bound rare earth elements and selectively eluting and removing one or more rare earth elements from said immobilized phase.

The stationary immobilized phase herein is contemplated to include any immobilized phase that may have selective affinity for one or more REEs. Preferably, the stationary immobilized phase herein comprises, consists essentially of, or consists of a protein-based stationary immobilized phase. A protein herein is understood as being composed of amino acids. The immobilized phase of protein within the column can then act to bind one or more REEs and allow for REE purification.

The protein is preferably a REE binding protein comprising the repeating sequence X₁X₂X₃X₄X₅X₆X₇X₈X₉ wherein X denotes any amino acid, and X₁ is D or E, X₂ is A, T, or S, X₃ is D, E or N, X₄ is G, A, or F, X₅ is D, X₆ is G, S, or D, X₇ is Y, L, V, F, I, E or W, X₈ is A, V, I, L, For T, X₉ is D, E, or N. The REE binding protein may also be described as comprising a sequence with at least 75% identity to SEQ ID NO. 1 set out below. In other preferred embodiments, the REE-binding protein comprises, consists of, or consists essentially of the amino acid sequence set forth in SEQ ID NO. 1 herein, or a sequence with at least 75%, 80%, 85%, 90%, 91%, 92%, 93%, 94%, 95%, 96%, 97%, 98%, or 99% identity to SEQ ID NO. 1:

```
LENGTH: 112
TYPE: PRT
ORGANISM: Nocardioides zeae
SEQUENCE: 1
SEQ ID NO 1
Pro Ser Ser Thr Glu Tyr Asp Ala Asp Gly Asp Gly Tyr Val Asp
1 5 10 15
Thr Arg Glu Ser Asp Thr Asp Gly Asp Gly Tyr Val Asp Thr Ile
                                20 25 30
Glu Thr Asp Thr Asp Gly Asp Gly Trp Val Asp Thr Val Ala Thr
                                35 40 45
Asp Thr Asp Gly Asp Gly Tyr Ile Asp Thr Val Ala Thr Asp Thr
                                50 55 60
Asp Gly Asp Gly Tyr Ala Asp Val Val Glu Thr Asp Thr Asp Gly
                                65 70 75
Asp Gly Tyr Thr Asp Glu Val Ala Tyr Asp Ala Asp Gly Asp Gly
                                80 85 90
Tyr Ile Asp Thr Val Glu Ala Asp Thr Asp Gly Asp Gly Tyr Thr
                                95 100 105
Asp Thr Val Val His Asp Gly
                                110
```

Such REE binding protein of SEQ ID NO. 1 is preferably truncated from a 137 amino acid full-length protein from Nocardioides zeae (SEQ ID NO. 2 shown below). The REE-binding protein therefore preferably has the domain sequence selected from SEQ ID NO. 1 noted above and can be expressed in E. coli using coding SEQ ID NO. 3 (shown below).

```
LENGTH: 137
TYPE: PRT
ORGANISM: Nocardioides zeae
SEQUENCE: 1
SEQ ID NO 2
Met Tyr Ala Ser Asn Ala Glu Pro Thr Pro Pro Pro Ala Pro Ser
1 5 10 15
Ser Thr Glu Tyr Asp Ala Asp Gly Asp Gly Tyr Val Asp Thr Arg
                                20 25 30
Glu Ser Asp Thr Asp Gly Asp Gly Tyr Val Asp Thr Ile Glu Thr
                                35 40 45
Asp Thr Asp Gly Asp Gly Trp Val Asp Thr Val Ala Thr Asp Thr
                                50 55 60
Asp Gly Asp Gly Tyr Ile Asp Thr Val Ala Thr Asp Thr Asp Gly
                                65 70 75
Asp Gly Tyr Ala Asp Val Val Glu Thr Asp Thr Asp Gly Asp Gly
                                80 85 90
Tyr Thr Asp Glu Val Ala Tyr Asp Ala Asp Gly Asp Gly Tyr Ile
                                95 100 105
Asp Thr Val Glu Ala Asp Thr Asp Gly Asp Gly Tyr Thr Asp Thr
                                110 115 120
Val Val His Asp Gly Ala Ser Asp Ser Gly Leu Glu Ser Thr Leu
                                125 130 135
Asp Ala
(E. coli)
LENGTH: 117
TYPE: PRT
ORGANISM: Nocardioides zeae
SEQUENCE: 1
SEQ ID NO 3
Met Gly Ser Gly Pro Ser Ser Thr Glu Tyr Asp Ala Asp Gly Asp
1 5 10 15
Gly Tyr Val Asp Thr Arg Glu Ser Asp Thr Asp Gly Asp Gly Tyr
                                20 25 30
Val Asp Thr Ile Glu Thr Asp Thr Asp Gly Asp Gly Trp Val Asp
                                35 40 45
Thr Val Ala Thr Asp Thr Asp Gly Asp Gly Tyr Ile Asp Thr Val
                                50 55 60
Ala Thr Asp Thr Asp Gly Asp Gly Tyr Ala Asp Val Val Glu Thr
                                65 70 75
Asp Thr Asp Gly Asp Gly Tyr Thr Asp Glu Val Ala Tyr Asp Ala
                                80 85 90
Asp Gly Asp Gly Tyr Ile Asp Thr Val Glu Ala Asp Thr Asp Gly
                                95 100 105
Asp Gly Tyr Thr Asp Thr Val Val His Asp Gly Ser
                                110 115
```

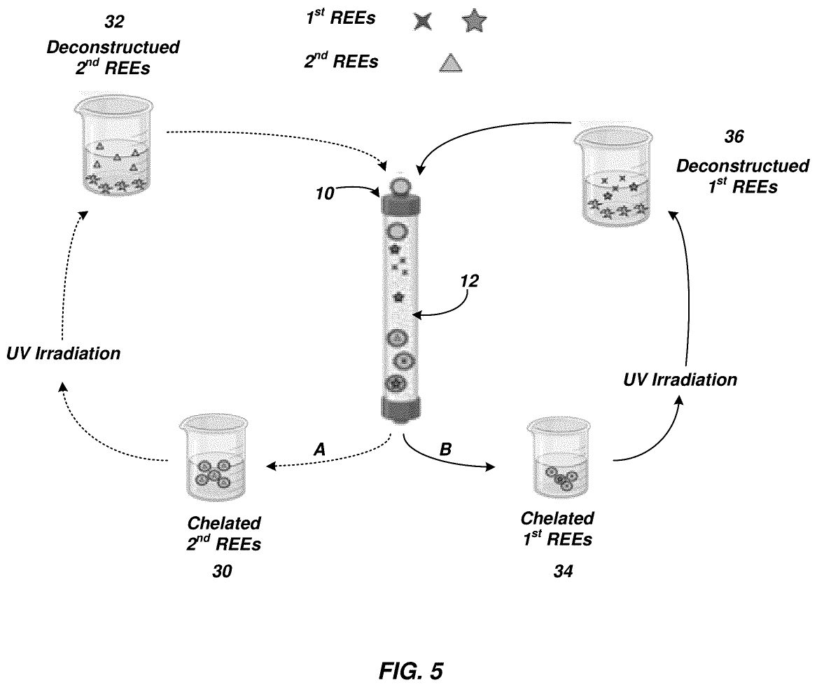

FIG. 5 illustrates an overall preferred system for the REE recovery and purification protocol herein. As illustrated, once again, a chromatographic column is shown at 10 having a stationary immobilized phase 12 that is preferably a protein-based immobilized phase, such as SEQ NO. 1 noted herein. As illustrated the column shows the presence of only the 1^{st} REE(s) that remain loaded on the immobilized phase after the previous removal of the 2^{nd} REE(s) as discussed above in connection with FIG. 1. This previous removal is illustrated as sequence “A” In this initial sequence “A”, as described above in FIG. 1, one or more of the 2^{nd} REE(s), that have a relatively weaker binding affinity to the stationary mobile phase 12 and a relatively higher binding efficiency to an added first chelating agent, are selectively removed from the column in chelated form at 30, and then subject to UV irradiation to provide the 2^{nd} REE(s) in deconstructed form. This deconstructed form of the 2^{nd} REE(s) may then be reintroduced into the column for another sequence of purification.

Next, in sequence “B”, and upon addition of the second chelating agent that has relatively stronger binding affinity for 1^{st} REE(s) than the protein-based immobilized phase, the chelated 1^{st} REE(s) are removed from the column as shown generally at 34. Upon UV irradiation the chelated 1^{st} REE(s) are deconstructed therefore providing an initially purified amount of the 1^{st} REE(s) as shown generally at 36. Such initially purified 1^{st} REE(s) may then be reintroduced in the column for subsequent and further chromatographic purification.

FIG. 5 illustrates a preferred apparatus 40 to collect the output of the column 10 shown in FIG. 1, 3 or 4 to provide for UV irradiation and chelator/REE deconstruction. The preferred apparatus 40 therefore includes an inlet 42 to receive the chelated REEs (e.g., 1^{st} REE(s) or 2^{nd} REE(s) shown in FIG. 5). The apparatus includes a UV lamp 44 that can be submerged in the eluant from the column containing the chelated REEs. In addition, the apparatus includes a reflective inner layer 46 that bounces back photons from the UV source that are not absorbed by the cleated REEs, thereby increasing the efficiency of the UV deconstruction of the chelated REEs that are recovered from the column. A stirrer is shown at 48. Finally, the apparatus includes an outlet 50 that is suitable for collection of the deconstructed and non-chelated REEs that may also contain chelator molecule impurities. The outlet 50 may be configured to deliver the deconstructed and non-chelated REEs and any chelator molecule impurities to the chromatography column described herein (see FIG. 5) for additional purification. As therefore may be appreciated, the purification system shown in FIG. 5 may be made continuous.

### Working Examples

### Confirmation of REE Binding to a Stationary Immobilized Protein Phase

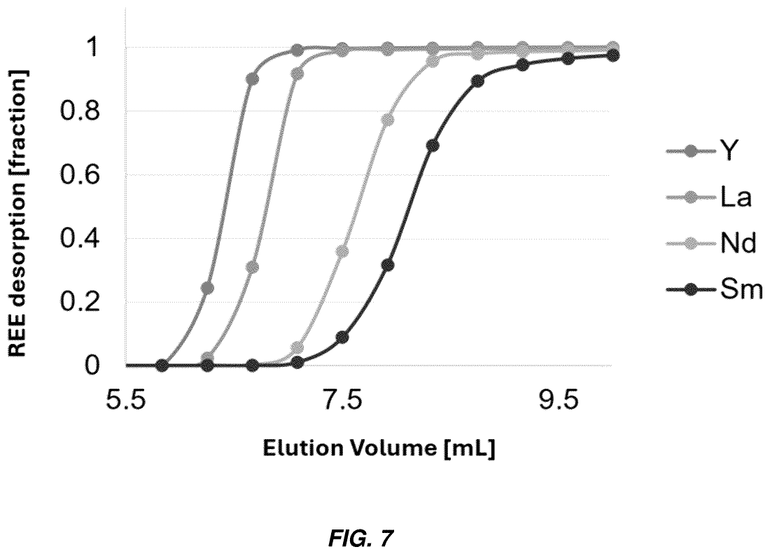

Attention is directed to FIG. 7 which shows the results of equimolar loading of Y, La, Nd and Sm onto a chromatographic column that employed a stationary immobilized protein phase of SEQ NO. 1 noted above. Namely, the stationary immobilized protein phase was the protein identified above as SEQ NO. 1. The identified elements were loaded onto the column and it was demonstrated that the four different REEs could be: (1) immobilized on the protein column; and (2) sequentially eluted off of the protein column. This then confirmed that a protein column in a column chromatograph environment could be employed for purification of REEs.

### Confirmation of REE Chelation and Passage of Chelated REEs Through a Protein Immobilized Phase

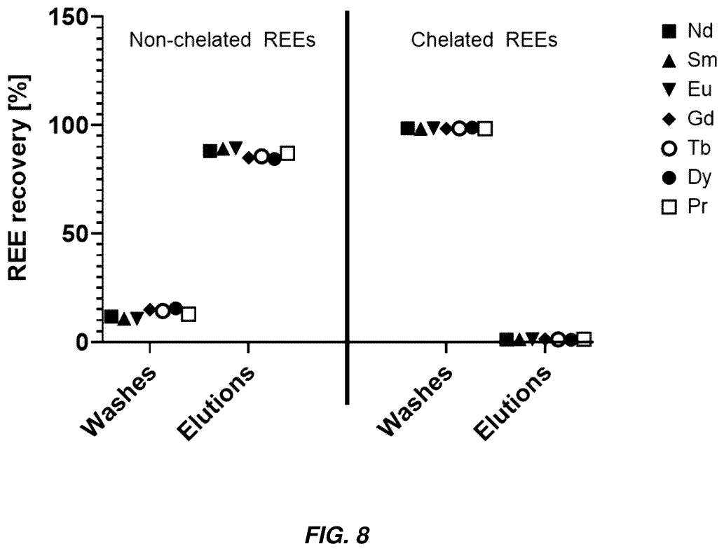

Both chelated and non-chelated forms of REEs were loaded onto a stationary immobilized protein phase having SEQ NO. 1 noted above. The REEs were Nd, Sm, Eu, Gd, Tb, Dy and Pr. Attention is directed to FIG. 8. As illustrated these REEs in non-chelated form, after over-loading onto the immobilized protein phase in the column, effectively remain bound to the protein immobilized phase. Some fraction (around 10-15% of the REEs) would wash from the column using buffer as the washing medium due to overloading. The remaining REEs bound to the protein column could then be eluted from the protein immobilized phase in the column and recovered. When such REEs were chelated, as can be observed, nearly 100% of such chelated REEs wash off the column using buffer as the washing medium. Accordingly, 0% of such REEs are available for a step of elution. This then confirms that non-chelated REEs can be selectively recovered and purified in elution fractions from a column having a protein based immobilized phase. By contrast, chelated REEs will pass through a protein based immobilized phase of the column and cannot be purified further when in the chelated state.

Confirmation the Prior Chelated REE Chelation Subject to UV Irradiation can then be Selectively Eluted in Column Chromatography

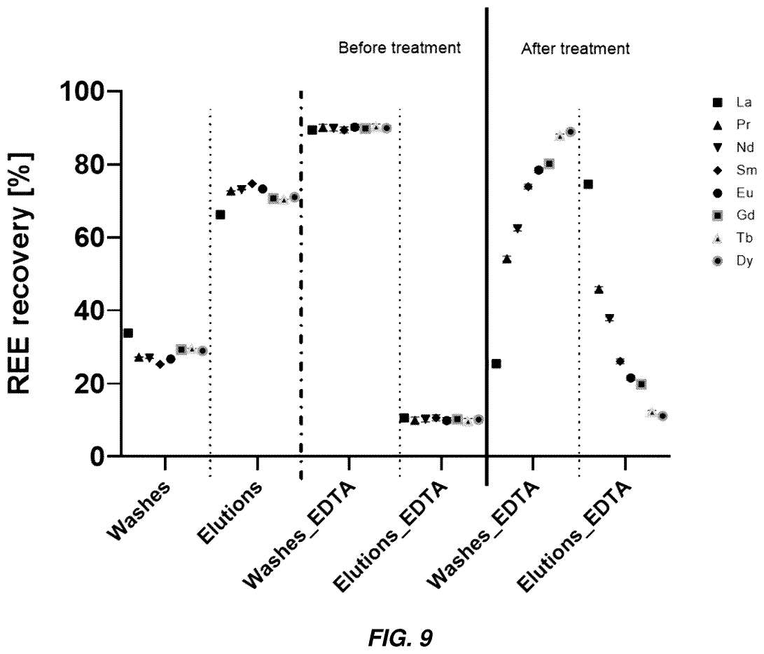

Attention is directed to FIG. 9 which illustrates the percent recovery of the indicated REEs (La, Pr, Nd, Sm, Eu, Gd, Tb and Dy) when chelated and loaded onto the protein immobilized phase in the column described by SEQ. NO. 1 noted herein, both before UV treatment and after UV treatment. As can be observed, before UV treatment, most of the chelated REEs are recovered from the column after a buffer wash, and are not generally subject to elution and chromatographic purification. After UV irradiation and deconstruction of the REE-chelator binding, the remaining REEs can be loaded onto the protein immobilized phase in the column and selectively eluted off of the column. This demonstrates that chelated REEs when subject to UV irradiation allows for further recycling and purification of REE mixtures.

### Confirmation of Chelator-REE Deconstruction

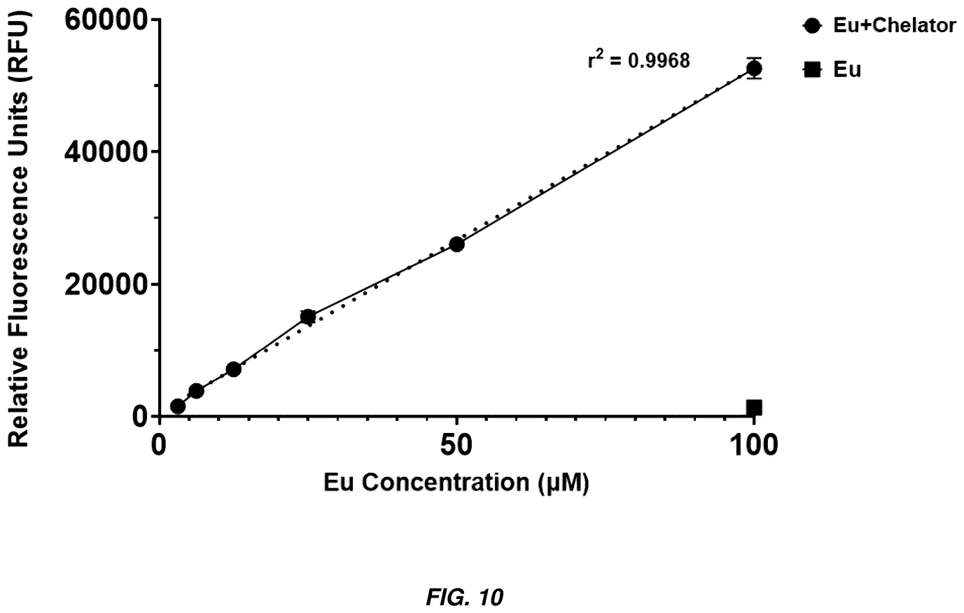

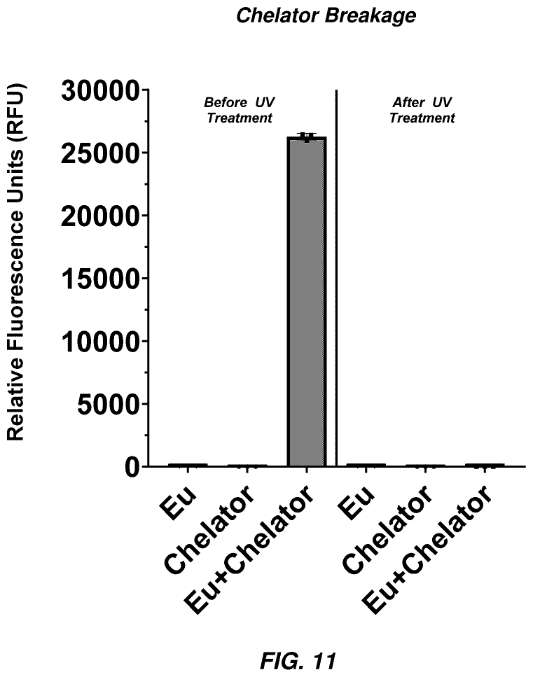

Attention is first directed to FIG. 10 which is a plot of relative fluorescence units (RFU) versus Eu concentration. It is noted that Eu can be considered a REE with relatively long-lived luminescence and relatively high stokes-shift. As can be observed in FIG. 10, when chelated, one can observe the identified RFU over the indicated concentration range, whereas non-chelated Eu does not efficiently receive energy from the excitation event and exhibits the indicated low luminescence. FIG. 11 is a plot of observed RFU (time resolved luminescence) for the identified samples. Eu (unchelated) shows, before application of UV irradiation, relatively low RFU whereas chelated Eu (Eu+EDTA) shows luminescence and relatively high RFU values. After application of UV light, both the Eu and Eu+EDTA (which has now been deconstructed due to the application of UV irradiation) shows relatively low luminescence and RFU values, thereby confirming the ability of utilizing UV light to deconstruct the REE/chelator complex formed herein.

### Preferred Parameters for UV Irradiation

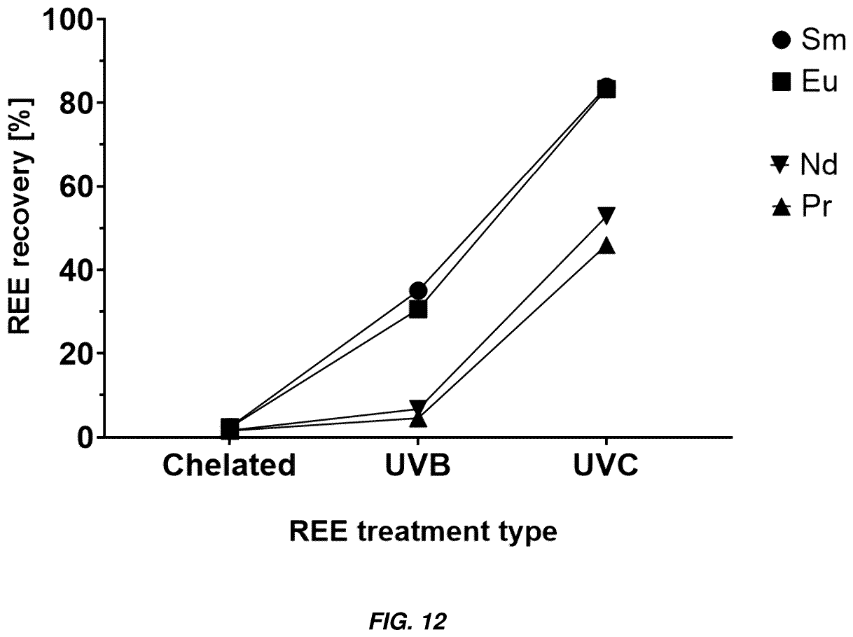

Attention is directed to FIG. 12 which illustrates the effect of irradiation wavelength and irradiation intensity on REE recovery. At a lower average irradiation wavelength with higher power output (mostly within the 200 nm and 280 nm range with an optimal wavelength of 254 nm, denoted as UVC) at 36W with reflective surfaces, REE recovery increased by up to 172% than higher average irradiation wavelengths with a lower power output (mostly within the 280 nm and 320 nm range with an optimal wavelength of 302 nm, denoted as UVB) at 25W without reflective surfaces. REEs used in this study were a Sm/Eu mixture and Pr/Nd mixture at 1.9 mM total REE concentrations to represent heavier and lighter elements, respectively. This data confirms that the irradiation wavelength and intensity can contribute to the % REE recovery.

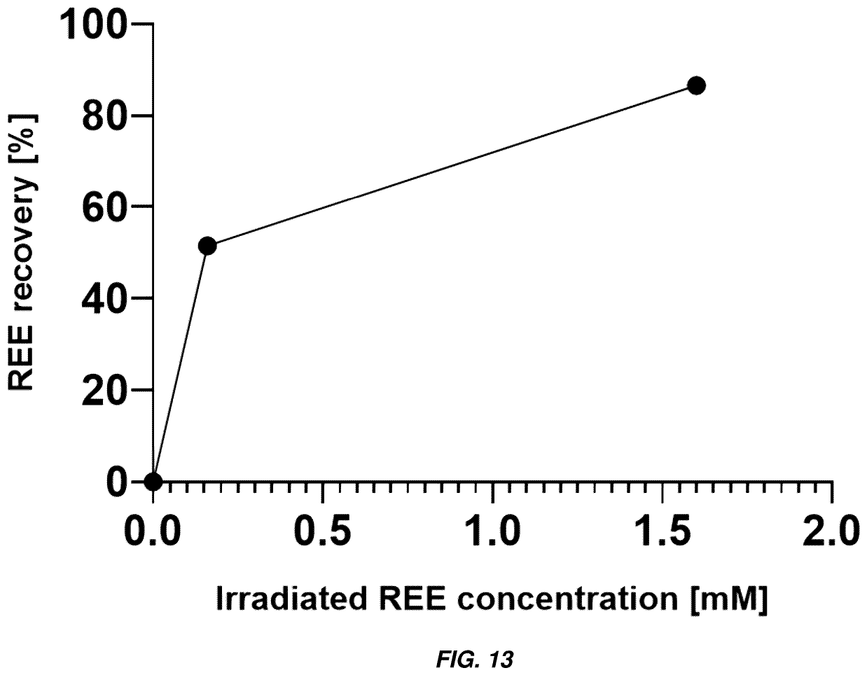

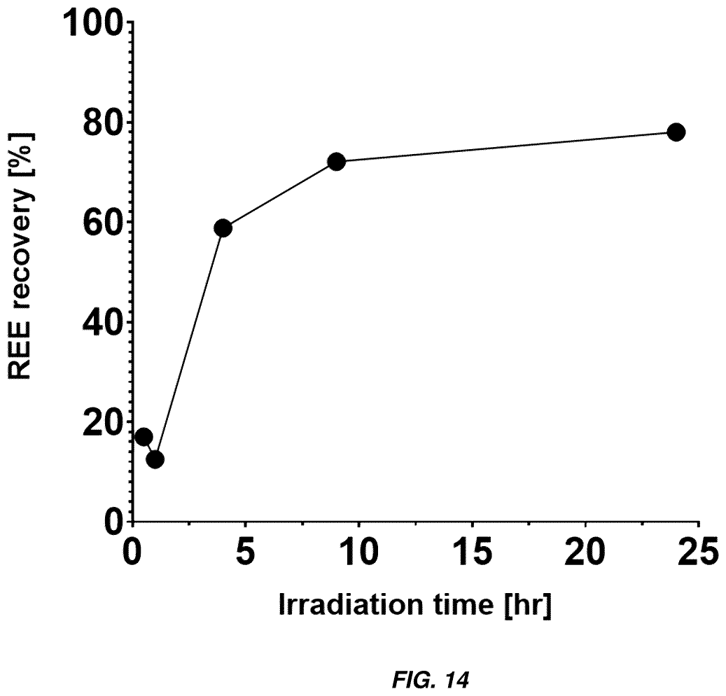

FIG. 13 shows the correlation of % REE recovery and chelator-REE complex concentration. Loaded REE input consisted of a chelated mixture of Sm and Eu and it was observed that higher concentrations had a higher % REE recovery. Similarly, FIG. 14 depicts the increase in % REE recovery as a function of irradiation time. It is observed that recovery plateaus at 8 hours for the Sm/Eu mixture at 1.9 mM. The data shown in FIG. 13-14 suggest that the UV irradiation efficacy is correlated to the concentration of intact REE-chelator complexes, which decrease with longer periods of irradiation.

Collectively, FIG. 12-14 elucidate the kinetics of chelator degradation, where the efficacy of UV irradiation will taper as the concentration of intact chelating molecules decreases upon greater total energy exposure (lower wavelength, higher wattage, longer exposure time). A continuous system that supplies chelated REEs into the reaction chamber, including those freshly washed or eluted off a purification column, is therefore preferable to maintain energy efficiency and reduce acid/base consumption.

### Chelator Types can Influence Recovery Yield and Purity of REEs

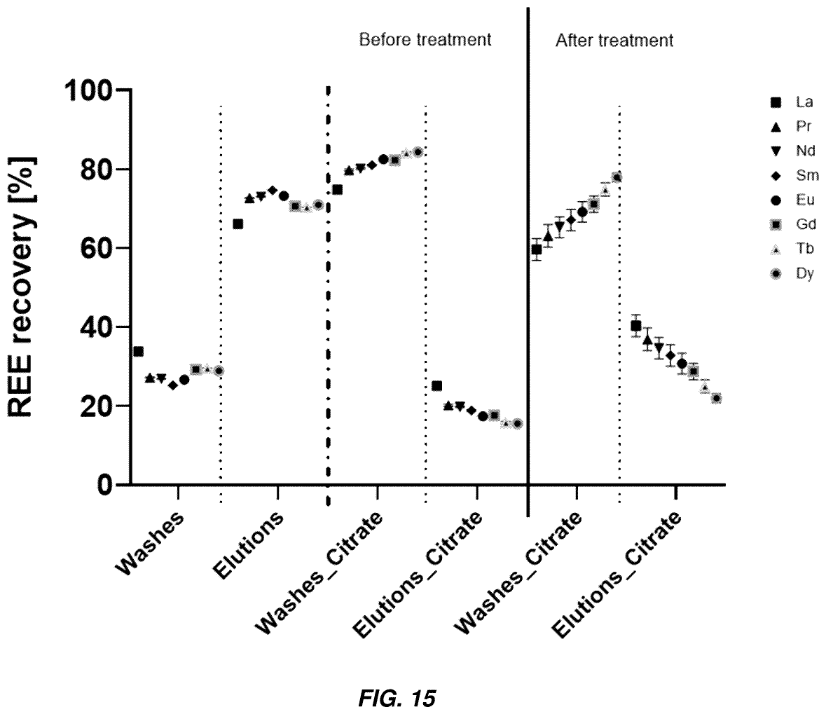

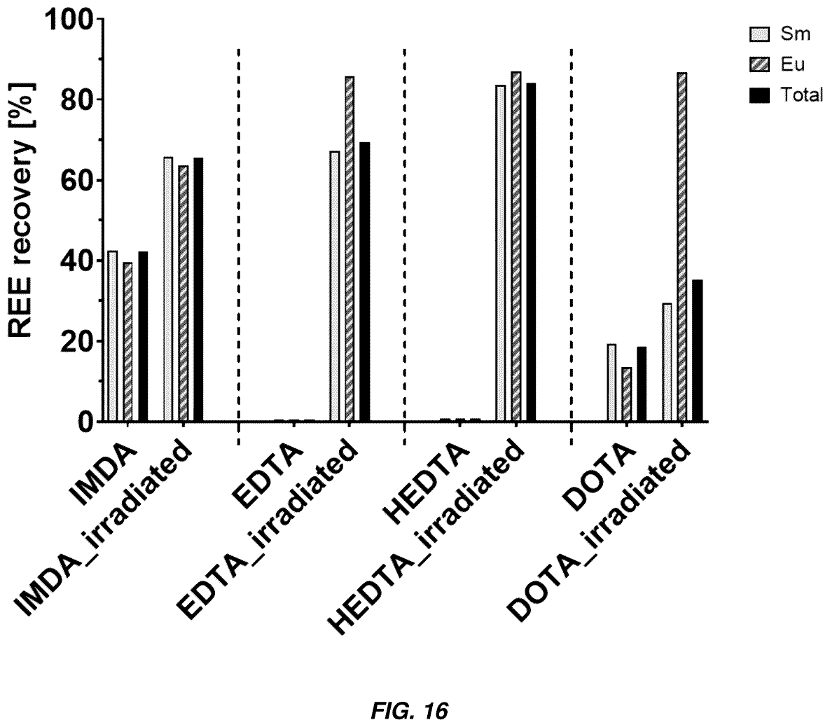

FIG. 15 depicts elution profiles of citrate in contrast to FIG. 9, which was performed with EDTA. Noticeably, differences in % recovery of individual elements using citrate are much smaller across light to heavy REEs in comparison to FIG. 9. EDTA can therefore be considered as a chelator-UV irradiation pair with greater selectivity across the different REEs when compared to citrate. In FIG. 16, four different chelating molecules were tested to compare recovery and selectivity. HEDTA, for example, has the highest recovery percentage whereas DOTA has the highest selectivity. These data support that different chelating molecules will have varying properties that can be exploited for REE separation and/or recovery when paired with UV irradiation.

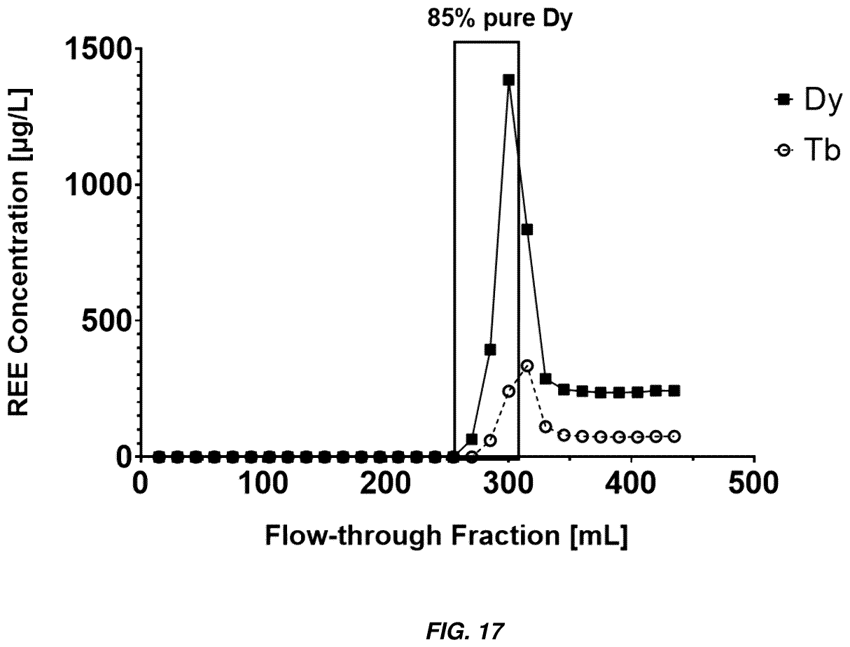

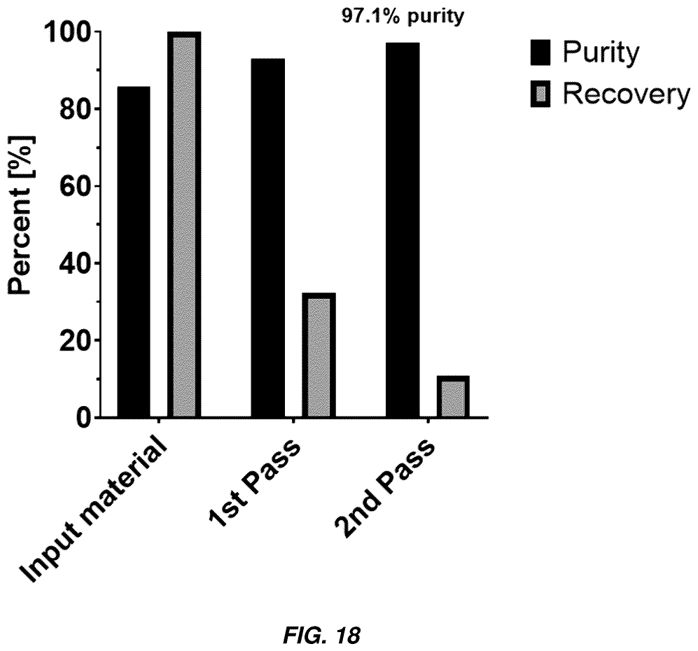

Attention is directed towards FIG. 17, which demonstrates isolation of a Dy/Tb mix at 85% Dy purity in the flow through when a saturating amount of heavy REEs was loaded onto a protein column with SEQ ID 1 at a starting purity of 75%. FIG. 18 shows that we can improve Dy purity to 97.1% using an alternative chelating molecule with greater specificity. First, EDTA was added to the simulated DY/Tb mixture (85% Dy/15% Tb) at a 30% molar equivalent chelation. This mixture was then loaded onto the protein column and Dy was enriched to 93% purity in the flow through. In a second pass, the purity of the resulting mixture was enhanced to 97.1% Dy while maintaining more than 11% of the original starting material. After each pass, UV irradiation is an effective method to reset the species of chelated REEs (or decreasing the concentration of chelated REEs, as shown in FIG. 14-15) for further purification without the need for the application of strong acids or bases. On the other hand, utilizing said acids or bases not only dilute the REE mixtures but may require excessively large volumes at the industrial scale (slowing down the process, which is limited to flow rates of the purification system) and can be environmentally undesirable.

As demonstrated with FIG. 15-18, it is shown that various chelator types can be utilized to achieve unique REE separations through multiple steps. Incorporating a continuous flow UV chamber within the purification system that irradiates freshly chelated REEs at higher concentrations is thought to be ideal, which, in addition to fresh REE feedstock, will process chelated REEs that have been washed or eluted off the column for further separation.

1. A method for rare earth element recovery and purification comprising:
a. providing a mixture of rare earth elements comprising one or more of first rare earth elements and one or more of second rare earth elements;
b. providing a first chelating agent and chelating one or more of said first rare earth elements wherein one or more of said second rare earth elements remain unchelated;
c. introducing one or more of said first chelated rare earth elements and one or more of said unchelated second rare earth elements to a chromatography column having a stationary immobilized phase wherein one or more of said first chelated rare earth elements pass through the column and one or more of said second unchelated rare earth elements are bound to said stationary immobilized phase; and
d. exposing one or more of said first chelated rare earth elements that pass through said column to ultraviolet irradiation and deconstructing one or more of said first chelated rare earth elements and recovering one or more of said first rare earth elements.

2. The method of claim 1 including eluting said second unchelated rare earth elements bound to said stationary immobilized phase from said column.

3. The method of claim 1 wherein said one or more first rare earth elements comprises Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr.

4. The method of claim 1 wherein said one or more second rare earth elements comprises Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr.

5. The method of claim 1 wherein said stationary immobilized phase comprises a protein.

6. The method of claim 5 wherein said protein comprises the repeating sequence X₁X₂X₃X₄X₅X₆X₇X₈X₉ wherein X denotes any amino acid, and X₁ is D or E, X₂ is A, T, or S, X₃ is D, E or N, X₄ is G, A, or F, X₅ is D, X₆ is G, S, or D, X₇ is Y, L, V, F, I, E or W, X₈ is A, V, I, L, F or T, X₉ is D, E, or N.

7. The method of claim 5 wherein the protein comprises an amino acid sequence with at least 75% identity to SEQ ID NO. 1.

8. The method of claim 1 wherein said UV irradiation has a wavelength in the range of 100 nm to 315 nm.

9. The method of claim 1 wherein exposing of said one or more of said first chelated rare earth elements that pass through said column to ultraviolet irradiation comprises introducing said one or more of said first chelated rare earth elements to an inlet of an apparatus that provides a UV lamp including a reflective inner layer to reflect UV light.

10. A method for rare earth element recovery and purification comprising:
a. providing a mixture of rare earth elements comprising one or more of first rare earth elements and one or more of second rare earth elements;
b. providing a chromatography column having a stationary immobilized phase and binding one or more of said first rare earth elements and one or more of said second rare earth elements to said stationary immobilized phase;
c. eluting said chromatograph column with a first chelating agent, wherein said first chelating agent chelates with said one or more of said second rare earth elements and removes said one or more of said second rare earth elements from said chromatography column, wherein one or more of said first rare earth elements remain bound to said column;
d. exposing one or more of said second chelated rare earth elements with ultraviolet irradiation and deconstructing one or more of said second chelated rare earth elements and recovering one or more of said second rare earth elements;
e. eluting said chromatography column with a second chelating agent wherein said second chelating agent chelates with one or more of said first rare earth elements bound to the column and removes one or more of said first rare earth elements from said chromatographic column; and
f. exposing one or more of said first chelated rare earth elements with ultraviolet irradiation and deconstructing one or more of said first chelated rare earth elements and recovering one or more of said first rare earth elements.

11. The method of claim 10 wherein said one or more first rare earth elements comprises Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr.

12. The method of claim 10 wherein said one or more second rare earth elements comprises Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr.

13. The method of claim 10 wherein said stationary immobilized phase comprises a protein.

14. The method of claim 13 wherein said protein comprises the repeating sequence X₁X₂X₃X₄X₅X₆X₇X₈X₉ wherein X denotes any amino acid, and X₁ is D or E, X₂ is A, T, or S, X₃ is D, E or N, X₄ is G, A, or F, X₅ is D, X₆ is G, S, or D, X₇ is Y, L, V, F, I, E or W, X₈ is A, V, I, L, F or T, X₉ is D, E, or N.

15. The method of claim 10 wherein the protein comprises an amino acid sequence with at least 75% identify to SEQ ID NO. 1.

16. The method of claim 10 wherein said UV irradiation has a wavelength in the range of 100 nm to 315 nm.

17. The method of claim 10 wherein exposing of said one or more of said first chelated REEs that pass through said column to ultraviolet irradiation comprises introducing said one or more of said first chelated REEs to an inlet of an apparatus that provides a UV lamp including a reflective inner layer to reflect UV light.

18. A method for rare earth element recovery and purification comprising:
a. providing a mixture of rare earth elements comprising one or more of first rare earth elements and one or more of second rare earth elements;
b. providing a first chelating agent and chelating one or more of said first and second rare earth elements;
c. exposing one or more of said first and second chelated rare earth elements to ultraviolet irradiation and (i) deconstructing one or more of said second chelated rare earth elements to an unchelated form; (ii) maintaining said one or more of said first chelated rare earth elements in chelated form;
a. introducing one or more of said second unchelated rare earth elements and one or more of said chelated first rare earth elements to a chromatography column having a stationary immobilized phase wherein one or more of said second unchelated rare earth elements bind to said stationary immobilized phase and one or more of said chelated first rare earth elements pass through said chromatography column.

19. The method of claim 18 including eluting one or more of said second unchelated rare earth elements bound to said stationary immobilized phase from said column.

20. The method of claim 18 wherein said one or more first rare earth elements comprises Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr.

21. The method of claim 18 wherein said one or more second rare earth elements comprises Sc, Y, La, Ce, Pr, Nd, Pm, Sm, Eu, Gd, Tb, Dy, Ho, Er, Tm, Yb, Lu, Ac, Th, Pa, U, Np, Pu, Am, Cm, Bk, Cf, Es, Fm, Md, No, or Lr.

22. The method of claim 18 wherein said stationary immobilized phase comprises a protein.

23. The method of claim 22 wherein said protein comprises the repeating sequence X₁X₂X₃X₄X₅X₆X₇X₈X₉ wherein X denotes any amino acid, and X₁ is D or E, X₂ is A, T, or S, X₃ is D, E or N, X₄ is G, A, or F, X₅ is D, X₆ is G, S, or D, X₇ is Y, L, V, F, I, E or W, X₈ is A, V, I, L, F or T, X₉ is D, E, or N.

24. The method of claim 22 wherein the protein comprises an amino acid sequence with at least 75% identity to SEQ ID NO. 1.

25. The method of claim 18 wherein said UV irradiation has a wavelength in the range of 100 nm to 315 nm.

26. The method of claim 18 wherein exposing of said one or more of said first chelated rare earth elements that pass through said column to ultraviolet irradiation comprises introducing said one or more of said first chelated rare earth elements to an inlet of an apparatus that provides a UV lamp including a reflective inner layer to reflect UV light.


SEQUENCE LISTING (3 sequences)

SEQ ID NO: 1 - protein, 112 aa, Nocardioides sp.
PSSTEYDADGDGYVDTRESDTDGDGYVDTIETDTDGDGWVDTVATDTDGDGYIDTVATDTDGDGYADVVETDTDGDGYTDEVAYDADGDGYIDTVEADTDGDGYTDTVVHDG

SEQ ID NO: 2 - protein, 137 aa, Nocardioides sp.
MYASNAEPTPPPAPSSTEYDADGDGYVDTRESDTDGDGYVDTIETDTDGDGWVDTVATDTDGDGYIDTVATDTDGDGYADVVETDTDGDGYTDEVAYDADGDGYIDTVEADTDGDGYTDTVVHDGASDSGLESTLDA

SEQ ID NO: 3 - protein, 117 aa, Nocardioides sp.
MGSGPSSTEYDADGDGYVDTRESDTDGDGYVDTIETDTDGDGWVDTVATDTDGDGYIDTVATDTDGDGYADVVETDTDGDGYTDEVAYDADGDGYIDTVEADTDGDGYTDTVVHDGS